(19) United States
(12) Patent Application Publication
(10) Pub. No.: US 2018/0025699 A1
(43) Pub. Date: Jan. 25, 2018

(54) COMMUNICATION APPARATUS AND CONTROL METHOD

(71) Applicant: KYOCERA Corporation, Kyoto-shi (JP)

(72) Inventors: Taro IIO, Yokohama-shi (JP); Daisuke MORI, Yokohama-shi (JP); Takuya TSUJI, Yokohama-shi (JP); Yasuhiro FUKUSHIMA, Okazaki-shi (JP)

(21) Appl. No.: 15/658,365

(22) Filed: Jul. 24, 2017

(30) Foreign Application Priority Data
Jul. 25, 2016 (JP) 2016-145464

(51) Int. Cl. G09G 5/00; G09G 5/14

(52) U.S. Cl. CPC G09G 5/006; G09G 5/14; G09G 2330/021; G09G 2360/04; G09G 2360/08; G09G 2310/04; H04W 88/02

(57) ABSTRACT

A communication apparatus includes a display; an application processor that is configured to control update of the display; and a modem processor that is configured to control a modem, wherein the modem processor is further configured to control the update of the display in place of the application processor.

### CROSS-REFERENCE TO RELATED APPLICATION

The present application claims priority to and incorporates by reference the entire contents of Japanese Patent Application No. 2016-145464 filed in Japan on Jul. 25, 2016.

### FIELD

The present application relates to a communication apparatus and a control method.

### BACKGROUND

Conventionally, there has been known a portable electronic apparatus that includes a first housing, a second housing, and a connection unit that connects the first housing to the second housing in an openable/closable manner. The first housing includes an operation unit, and the second housing includes a main display that is disposed on a main surface of the second housing and a sub-display that is disposed on a rear surface on a side opposite to the main display.

In a communication apparatus including a display, reducing power consumption due to display is required.

### SUMMARY

A communication apparatus and a control method is disclosed.

According to one aspect, there is provided a communication apparatus comprising: a display; an application processor that is configured to control update of the display; and a modem processor that is configured to control a modem, wherein the modem processor is further configured to control the update of the display in place of the application processor.

According to one aspect, there is provided a method for controlling a communication apparatus including a display, an application processor that is configured to control update of the display, and a modem processor that is configured to control a modem, wherein the modem processor controls the update of the display in place of the application processor.

The above and other objects, features, advantages and technical and industrial significance of this application will be better understood by reading the following detailed description of presently preferred embodiments of the application, when considered in connection with the accompanying drawings.

### BRIEF DESCRIPTION OF THE DRAWINGS

FIG. 1 is a view illustrating an outer appearance of a communication apparatus according to embodiments in an open state;

FIG. 2 is a view illustrating an outer appearance of the communication apparatus in a closed state;

FIG. 3 is a functional block diagram illustrating a schematic configuration example of the communication apparatus according to embodiments;

FIG. 4 is a view for illustrating a timing of a request for updating time display; and

FIG. 5 is a flowchart illustrating an example of processing executed by the communication apparatus.

### DETAILED DESCRIPTION OF THE PREFERRED EMBODIMENTS

A communication apparatus according to embodiments will now be described with reference to the accompanying drawings. The communication apparatus according to the embodiments can be various kinds of apparatuses with a modem, such as a portable electronic apparatus, a smartphone, a wearable apparatus, a desktop personal computer (PC), a notebook PC, a tablet PC, a home electric appliance, an industrial apparatus, a factory-automation (FA) apparatus, and an exclusive terminal.

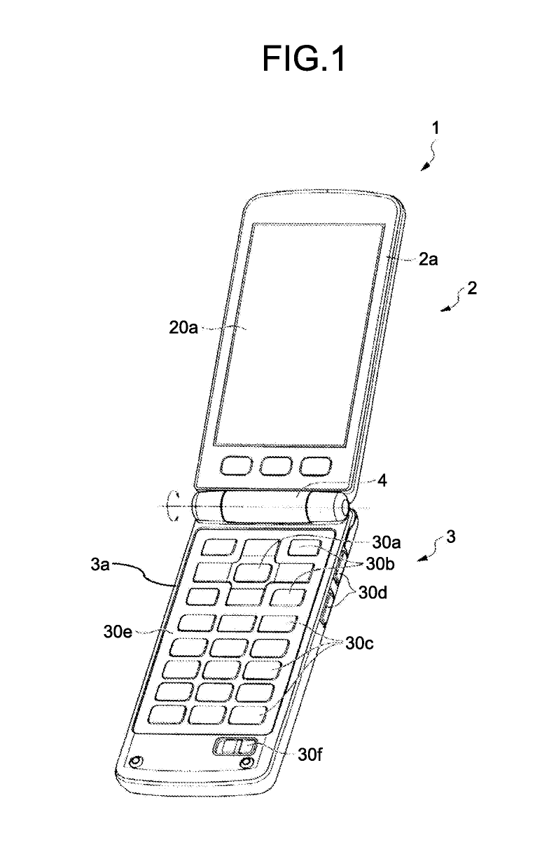

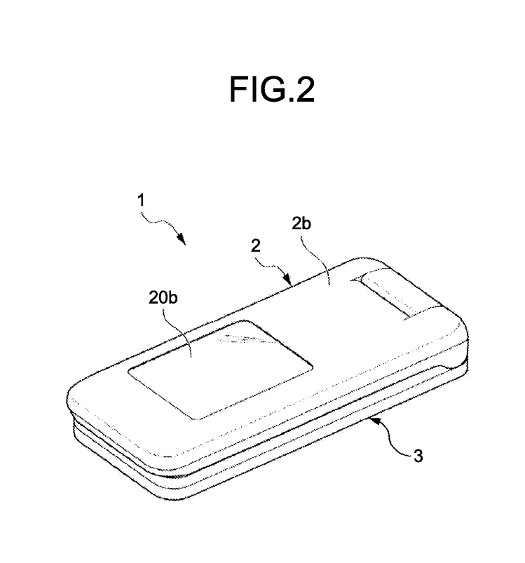

FIG. 1 is a view illustrating an outer appearance of a communication apparatus 1 according to embodiments in an open state. FIG. 2 is a view illustrating an outer appearance of the communication apparatus 1 that is a closed state. The communication apparatus 1 is what is called a folding feature phone. In the communication apparatus 1, an upper housing 2 and a lower housing 3 are rotatably connected to each other through a hinge 4. When the communication apparatus 1 is open, a main surface 2a of the upper housing 2 and a main surface 3a of the lower housing 3 are exposed.

The upper housing 2 includes a main display 20a and a sub-display 20b. The main display 20a is disposed on a main surface 2a of the upper housing 2. The sub-display 20b is disposed on a surface 2b on a side opposite to the main surface 2a. The main display 20a and the sub-display 20b display characters, images, objects for operation, pointers, and the like. The main display 20a and the sub-display 20b display, for example, time information as characters and images. When the main display 20a and the sub-display 20b are not differentiated, they may be collectively referred to as, simply, displays 20.

The lower housing 3 includes an operation key 30a, a function key 30b, a character key 30c, a side key 30d, a touch pad 30e, and a power supply switch 30f. The operation key 30a is used for determination in various kinds of operations or a scroll and the like in up-and-down and right-and-left directions. The function key 30b is used for operating various kinds of settings of the communication apparatus 1, a telephone book function, or various kinds of functions such as a mail function. The character key 30c is used for inputting numbers of a telephone number or characters and the like of email. The side key 30d is used for operating various kinds of settings of the communication apparatus 1, a telephone book function, or various kinds of functions such as a mail function. The touch pad 30e is, for example, an electrostatic capacitance contact sensor that detects contact on the lower housing 3, and receives a moving operation of a pointer and the like caused by movement of a contact position. The power supply switch 30f is a switch for turning on or off a main power supply of the communication apparatus 1. The operation key 30a, the function key 30b, the character key 30c, the side key 30d, the touch pad 30e, and the power supply switch 30f may be collectively referred to as an operation unit 30.

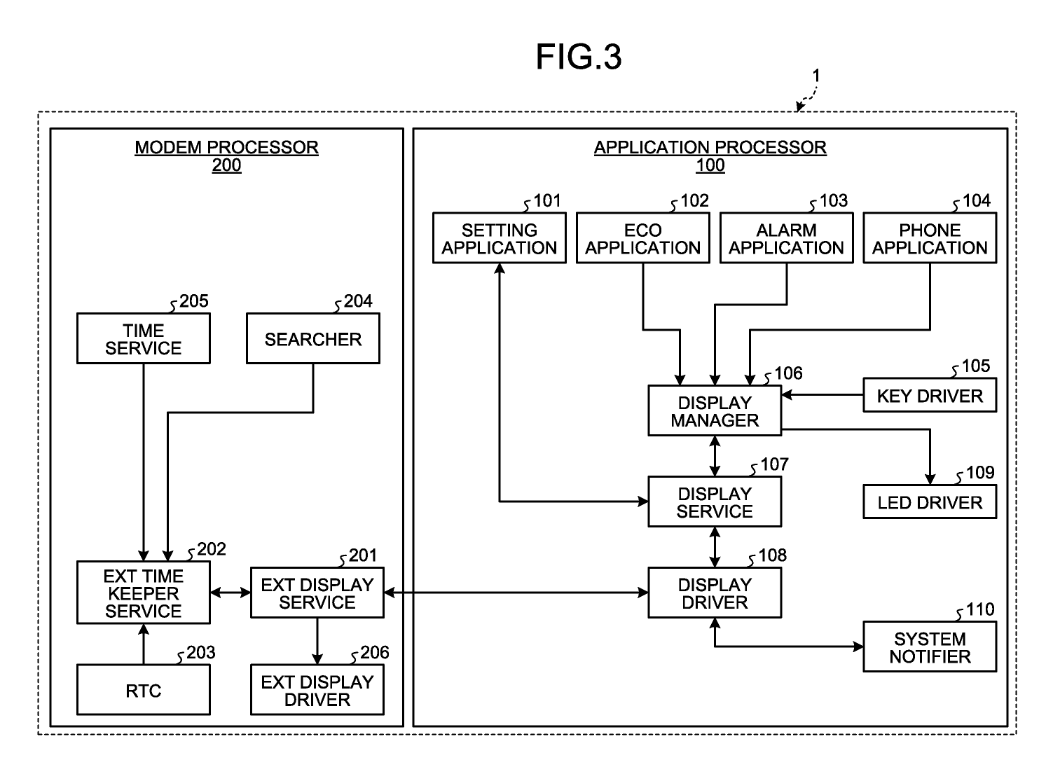

FIG. 3 is a functional block diagram illustrating a schematic configuration example of the communication apparatus 1 according to embodiments. As illustrated in FIG. 3, the communication apparatus 1 includes an application processor 100 and a modem processor 200.

The application processor 100 can include a processor capable of executing an operating system (which is also referred to as an OS) and application software (which is also referred to as an application) or a microcomputer and the like. Examples of the OS include a Linux (registered trademark) based OS such as Android (registered trademark) and iOS (registered trademark), and a Windows (registered trademark) based OS.

The application processor 100 includes a Setting application 101, an Eco application 102, an Alarm application 103, and a Phone application 104 as the application. The application processor 100 also includes a key driver 105, a display manager 106, a display service 107, a display driver 108, a light emitting diode (LED) driver 109, and a system notifier 110.

The modem processor 200 is hardware that functions as a communication interface performing wireless communication, and controls a modem. The modem processor 200 includes an Ext display service 201, an Ext time keeper service 202, a real time clock (RTC) 203, a searcher 204, a time service 205, and an Ext display driver 206.

The Setting application 101, the Eco application 102, the Alarm application 103, and the Phone application 104 of the application processor 100 are executed in the foreground or in the background. A state where the application is executed in the foreground means, for example, a state where an execution situation is displayed on the displays 20 so that a user can check the execution situation, or a state where a user is operable using the operation unit 30. A state where the application is executed in the background means, for example, a state where the execution situation is not displayed on the displays 20 and a user is not operable, or a state where the application is executed unintentionally.

The Setting application 101 provides a function for making and changing various kinds of settings involved in the time and display. Examples of the settings include settings for displaying the time in units of 12 hours or 24 hours, settings for defining a described language as Japanese or English, settings for a contrast value of display of the displays 20, settings of a time zone, and settings for display of an analog clock or a digital clock. Making and changing the settings is executed by operation and the like of a user on the operation unit 30. The communication apparatus 1 includes a database storing therein data related to the settings.

The Eco application 102 provides a function of setting an Eco mode or releasing the Eco mode with operation of a user. The Eco mode is a mode for reducing power consumption when the communication apparatus 1 operates. If an event for keeping display of the displays 20 is not generated for a predetermined time when the Eco mode is set, the communication apparatus 1 turns off the display of the displays 20 and lighting of a backlight for the displays 20. If an event for keeping the display of the displays 20 is not generated in a predetermined time when the Eco mode is released, the communication apparatus 1 keeps the display of the displays 20, but turns off the lighting of the backlight. An event is, for example, an operation on the operation unit 30. Even when the backlight of the communication apparatus 1 is turned off, the user can visually recognize the display of the displays 20.

The Alarm application 103 provides a function of notifying the user by display and voice at a predetermined timing. The Phone application 104 provides a calling function through wireless communication.

The communication apparatus 1 can execute two display modes that are a first display mode and a second display mode. In the first display mode, when a first condition is satisfied during the display of the displays 20, the display of the displays 20 and the lighting of the backlight are turned off.

In the second display mode, when the first condition is satisfied during the display of the displays 20, the display of the displays 20 is kept, but the lighting of the backlight is turned off.

The first condition corresponds to a condition in which an event for keeping the display of the displays 20 is not generated for a predetermined time. An event is, for example, an operation on the operation unit 30.

The display manager 106 sets one of the first and second display modes the display mode based on a determination criterion whether a second condition is satisfied.

If the second condition is satisfied, the display manager 106 sets the display mode to the first display mode. If not, the display manager 106 sets the display mode to the second display mode.

The second condition corresponds, for example, to a condition in which the Eco mode is set by a user. If the Eco mode is set, the display manager 106 sets the display mode to the first display mode. If not, the display manager 106 sets the display mode to the second display mode.

After setting the display mode to the first display mode or the second display mode, the display manager 106 notifies the display service 107 that the display mode is set to the first display mode or the second display mode.

The display service 107 keeps a state where one of the first display mode and the second display mode is set. The display service 107 notifies the display driver 108 of the current display mode.

Furthermore, the display service 107 acquires settings that are set in the Setting application 101 from the database, and notifies the display driver 108 of the settings.

The display driver 108 drives the displays 20, and controls update of the displays 20. The display driver 108 keeps a state where one of the first display mode and the second display mode is set.

The display driver 108 notifies the Ext display service 201 in the modem processor 200 of information on the display mode. The display driver 108 notifies the Ext display service 201 of the settings set in the Setting application 101.

The following describes the operation of the communication apparatus 1 in the first display mode. In the first display mode, the display driver 108 in the application processor 100 controls the update of the displays 20.

When the first display mode is set to the display mode, the display manager 106 determines whether the first condition is satisfied during the display of the displays 20.

For example, similarly to the above, the first condition indicates that an event for keeping the display of the displays 20 is not generated for a predetermined time. The display manager 106 detects presence/absence of input on the operation unit 30 based on presence/absence of notification from the key driver 105.

When determining that the first condition is satisfied, the display manager 106 controls the LED driver 109 to turn off the backlight. In addition, when determining that the first condition is satisfied, the display manager 106 sends a request for turning off the display of the displays 20 to the display service 107.

When receiving the request for turning off the display of the displays 20 from the display manager 106, the display service 107 sends the same request to the display driver 108.

When receiving the request for turning off the display of the displays 20 from the display service 107, the display driver 108 turns off the display of the displays 20. Along with this processing, the display driver 108 does not control the update of the displays 20.

The following describes the operation of the communication apparatus 1 in the second display mode. In the second display mode, the display driver 108 in the application processor 100 controls the update of the displays 20.

When the second display mode is set to the display mode, the display manager 106 determines whether the first condition is satisfied during the display of the displays 20.

For example, similarly to the above, the first condition indicates that an event for keeping the display of the displays 20 is not generated for a predetermined time. The display manager 106 detects presence/absence of input on the operation unit 30 based on presence/absence of notification from the key driver 105.

When determining that the first condition is satisfied, the display manager 106 controls the LED driver 109 to turn off the backlight. In addition, when determining that the first condition is satisfied, the display manager 106 sends a request for turning off display of the displays 20 to the display service 107.

When receiving the request for turning off the display of the displays 20 from the display manager 106, the display service 107 sends the same request to the display driver 108.

When receiving the request for turning off the display of the displays 20 from the display service 107 in the second display mode, the display driver 108 hands over execution of updating the displays 20 to the Ext display driver 206 through the Ext display service 201 in the modem processor 200. In this manner, the Ext display driver 206 in the modem processor 200 controls the update of the displays 20 in place of the display driver 108 in the application processor 100. After the handover, the display driver 108 does not control the update of the displays 20.

Subsequently, the following describes one of embodiments of the modem processor 200 that takes over the update of the displays 20 from the application processor 100. The embodiment describes an example in which the update of the displays 20 is performed on the update of time information handled by the modem processor 200.

After taking over the update of the displays 20 from the application processor 100, the Ext display service 201 in the modem processor 200 notifies the Ext time keeper service 202 of the takeover of the update of the displays 20.

The Ext time keeper service 202 acquires coordinated universal time (UTC) from the time service 205. The Ext time keeper service 202 sends the acquired UTC (which is also referred to as time information) to the Ext display service 201. The time service 205 can acquire UTC from the outside, for example, a base station.

The RTC 203 counts the time based on the UTC, and notifies the Ext time keeper service 202 of a timing of the update of the time. The timing of the update of the time is, for example, every one-minute interval. The Ext time keeper service 202 sends a request for updating time display to the Ext display service 201 at the timing of the update of the time.

The Ext display service 201 creates image data related to the time display based on the acquired time information. The Ext display service 201 creates, based on the acquired UTC, image data indicating the UTC. The Ext display service 201 creates, based on the acquired request for updating the time display, image data indicating the updated time.

The Ext display service 201 may create the image data in a form based on information (setting data) on various kinds of settings set or changed by the Setting application 101. The Ext display service 201 may create the image data based on format data related to display of a day and a time that are preliminarily held in the modem processor 200.

The Ext display service 201 sends the created image data to the Ext display driver 206.

The Ext display driver 206 drives the displays 20 and controls the update of the displays 20. The Ext display driver 206 displays the time on the displays 20 based on the image data acquired from the Ext display service 201.

As described above, in the communication apparatus 1, the modem processor 200 controls the update of the displays 20 in place of the application processor 100.

In the above-mentioned communication apparatus 1, power consumption required for execution of operation is large in the application processor 100 as compared with that in the modem processor 200. By contrast, the communication apparatus 1 according to the present application can operate with lower power consumption, since the modem processor 200 with smaller power consumption than the application processor 100 controls the update of the displays 20.

If the first condition is satisfied in the second display mode, the modem processor 200 controls the update of the displays 20 in place of the application processor 100. In a state where the first condition is satisfied in the second display mode, the application processor 100 can transit into a sleep state and reduce the power consumption of the communication apparatus 1 by controlling the update of the displays 20 with the modem processor 200 in place of the application processor 100.

The above embodiments describe a configuration where, in the second display mode, the modem processor 200 acquires the time information and displays the image based on the acquired time information on the displays 20; however the embodiments are not limited thereto. Any information that can be acquired by the modem processor 200 may be served as information displayed on the displays 20.

Again, explanation will be made with reference to FIG. 3. When the modem processor 200 is incapable of displaying an image based on the time information on the displays 20 due to occurrence of system malfunction in the modem processor 200 and the like, the Ext display service 201 notifies the display driver 108 in the application processor 100 of a request for displaying the time information. When receiving the request for displaying the time information from the Ext display service 201, the display driver 108 drives the displays 20, and displays an image based on the time information on the displays 20. In this manner, the communication apparatus 1 can display, even when the modem processor 200 is incapable of displaying an image based on the time information on the displays 20, the time information.

When being incapable of displaying an image based on the time information on the displays 20 due to the occurrence of the system malfunction in the modem processor 200 and the like, the modem processor 200 may restart the system. The modem processor 200 sends notification in which system malfunction occurs in the modem processor 200 or notification in which the modem processor 200 restarts the system to the system notifier 110 in the application processor 100.

When receiving the notification from the modem processor 200, the system notifier 110 sends call-back notification on system restart of the modem processor 200 to the display driver 108. When the second display mode is set to the display mode upon completion of the system restart of the modem processor 200, the display driver 108 may notify the Ext display service 201 in the modem processor 200 of a request for displaying the time information. In this manner, the communication apparatus 1 enables the modem processor 200 to display the time information even if the modem processor 200 restarts the system.

The searcher 204 performs intermittent reception from the base station regularly (for example, every 5.12 seconds). The Ext time keeper service 202 recognizes a timing of the intermittent reception of the searcher 204. In one of the embodiments of the present application, the Ext time keeper service 202 may synchronize a timing at which a request for updating the time display is sent to the Ext display service 201 with a timing at which the searcher 204 performs the intermittent reception.

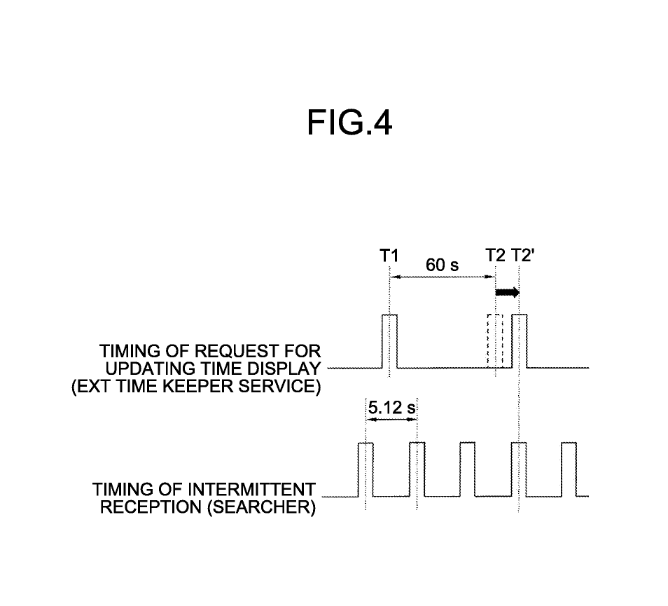

FIG. 4 is a view for illustrating a timing of a request for updating the time display. The Ext time keeper service 202 sends UTC to the Ext display service 201 at a time point T1 of acquiring the UTC from the time service 205. In this manner, the displays 20 display the time. The Ext time keeper service 202 receives notification of a timing of updating the time display (a time point when 60 seconds have passed from T1; and this time point is referred to as T2) from the RTC 203, but the Ext time keeper service 202 does not send a request for updating the time display to the Ext display service 201 at the time point T2. The Ext time keeper service 202 sends a request for updating the time display to the Ext display service 201 at a time point T2′ at which the searcher 204 performs the intermittent reception after the time point T2.

When there is no notification event and operation event (event of operation on the operation unit 30), the modem processor 200 transits into a sleep state that reduces the power consumption. The modem processor 200 needs to recover from a sleep state at a timing when the Ext time keeper service 202 sends a request for updating the time display to the Ext display service 201. The modem processor 200 also needs to recover form a sleep state at a timing when the searcher 204 performs the intermittent reception. As described above, the modem processor 200 synchronizes a timing of updating the time display with a timing of the intermittent reception. In this manner, the frequency with which the modem processor 200 recovers from a sleep state is reduced (in other words, the power consumption of the communication apparatus 1 is reduced) as compared with a case where the modem processor 200 does not synchronize a timing of updating the time display with a timing of the intermittent reception.

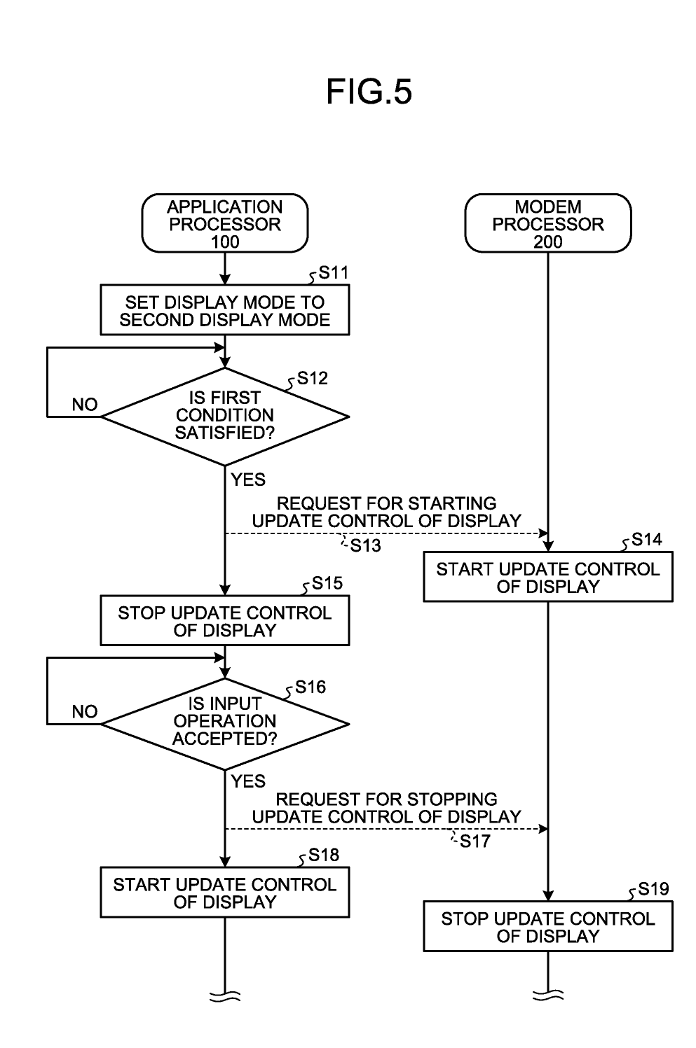

FIG. 5 is a flowchart illustrating an example of processing executed by the communication apparatus 1. Processing illustrated in FIG. 5 is executed by each of function units included in the application processor 100 and each of function units included in the modem processor 200.

The application processor 100 sets the display mode to the second display mode at Step S11. In the second display mode, the application processor 100 determines whether the first condition is satisfied during the display of the displays 20 (Step S12). When determining that the first condition is not satisfied during the display of the displays 20 (No at Step S12), the application processor 100 repeats the processing at Step S12.

When determining that the first condition is satisfied during the display of the displays 20 (Yes at Step S12), the application processor 100 sends a request for executing display operation to the modem processor 200 (Step S13).

When receiving the request for executing the display operation from the application processor 100, the modem processor 200 drives the displays 20, and starts update control of the displays 20 in place of the application processor 100 (Step S14). The modem processor 200 displays, for example, the time information on the displays 20.

When sending the request for executing the display operation to the modem processor 200, the application processor 100 stops the update control of the displays 20 (Step S15). The flowchart illustrates an example in which the application processor 100 executes the operation at Step S15 after the modem processor 200 performs the operation at Step S14, but the operation at Step S14 may be performed after the operation at Step S15, and the operation at Step S14 and the operation at Step S15 may be performed at the same time. After stopping the update control of the displays 20 at Step S15, the application processor 100 may transit into a sleep state.

The application processor 100 determines whether the operation unit 30 accepts input operation (the sleep state is canceled) in a state where the modem processor 200 controls the update of the displays 20 (Step S16). When determining that the operation unit 30 does not accept any input operation (No at Step S16), the application processor 100 repeats processing at Step S16.

When determining that the operation unit 30 accepts input operation (Yes at Step S16), the application processor 100 sends a request for stopping the update control of the displays 20 to the modem processor 200 (Step S17).

When sending the request for stopping the update control of the displays 20 to the modem processor 200, the application processor 100 drives the displays 20, and starts the update control of the displays 20 in place of the modem processor 200 (Step S18).

When receiving the request for stopping the update control of the displays 20 from the application processor 100, the modem processor 200 stops the update control of the displays 20 (Step S19). The flowchart illustrates that the operation at Step S19 performed by the modem processor 200 is executed after the operation at Step S18 performed by the application processor 100, but the operation at Step S18 may be performed after the operation at Step S19. The operation at Step S18 and the operation at Step S19 may be performed at the same time.

Some embodiments of the communication apparatus 1 according to the present application are not limited to the embodiments described above, and various modifications or changes can be made. For example, functions and the like included in components respectively can be rearranged so that the functions are not logically inconsistent, and a plurality of the components can be incorporated into one component or can be divided.

The embodiments describe the configuration and the operation of the communication apparatus 1; however, the embodiments are not limited thereto. The embodiments according to the present application may be formed as a control method and a non-transitory storage medium that stores a computer program including each of the components.

In the embodiments, if an event for keeping the display of the displays 20 is not generated for a predetermined time when the Eco mode is set, the communication apparatus 1 turns off the display of the displays 20 and the lighting of the backlight for the displays 20, and, if an event for keeping the display of the displays 20 is not generated for a predetermined time when the Eco mode is released, the communication apparatus 1 keeps the display of the displays 20 and turns off the lighting of the backlight; however the embodiments are not limited thereto. For example, if an event for keeping the display of the displays 20 is not generated for a predetermined time when the Eco mode is set, the communication apparatus 1 may turn off the display of the displays 20 or the lighting of the backlight for the displays 20, and, if an event for keeping display of the displays 20 is not generated for a predetermined time when the Eco mode is released, the communication apparatus 1 does not need to turn off the display of the displays 20 and the lighting of the backlight for the displays 20.

In the embodiments, the first condition indicates that an event for keeping the display of the displays 20 is not generated for a predetermined time and operation on the operation unit 30 is exemplified as the event, but the embodiments are not limited thereto. The event may be, for example, a notification event. Examples of the notification event may include a report notified by the Alarm application 103 and a notification of information received by the modem processor 200 from the outside.

The first condition may indicate that, for example, the communication apparatus 1 is in a closed state. When the communication apparatus 1 is in a closed state in the second display mode, in other words, if the first condition is satisfied, the modem processor 200 controls the update of the displays 20 in place of the application processor 100. At this time, the modem processor 200 may drive the sub-display 20b, and display the time information and the like on the sub-display 20b.

In the embodiments, the communication apparatus 1 sets the display mode to the first display mode or the second display mode based on a determination criterion whether the second condition is satisfied; however the embodiments are not limited thereto. The communication apparatus 1 may execute only the second display mode, or the communication apparatus 1 may simply set one of the first and second display modes to the display mode by select operation by a user.

In the embodiments, the second condition indicates, for example, whether the Eco mode is set by a user; however the embodiments are not limited thereto. The second condition may indicate whether a residual amount of a battery included in the communication apparatus 1 is equal to or more than a predetermined amount. For example, when the residual amount of the battery is equal to or larger than a predetermined amount, the communication apparatus 1 may set the display mode to the first display mode. When the residual amount of the battery is less than a predetermined amount, the communication apparatus 1 may set the display mode to the second display mode.

The second condition may indicate, for example, whether the communication apparatus 1 is in a closed state. For example, when not being in a closed state (or being an open state), the communication apparatus 1 may set the display mode to the first display mode. When being in a closed state, the communication apparatus 1 may set the display mode to the second display mode. When executing the display operation in the second display mode, the modem processor 200 may drive the sub-display 20b and display the time information and the like on the sub-display 20b.

In the embodiments, the Ext time keeper service 202 in the modem processor 200 sends a request for updating the time display to the Ext display service 201, and the Ext display service 201 creates image data indicating the updated time based on the acquired request for updating the time display; however the embodiments are not limited thereto. The Ext time keeper service 202 may send information on the updated time to the Ext display service 201, and the Ext display service 201 may create, based on the acquired information on the updated time, image data indicating the updated time.

In the embodiments, the modem processor 200 causes the RTC 203 to count the time based on the UTC acquired from the outside to create information on the update of time; however the embodiments are not limited thereto. The modem processor 200 may acquire the time information from the application processor 100 and cause the RTC 203 to count the time based on the time information to create the information on the update of time. In this case, in the second display mode, the modem processor 200 may acquire, at a timing when the modem processor 200 receives a request for starting the update control of the displays 20 (Step S13 in FIG. 5), the time information upon reception of the request from the application processor 100. In this manner, for example, when the time information is displayed by the modem processor 200, the time information can be displayed even if communication of the modem processor 200 is unavailable due to out-of-range of the communication and the like.

The present application can provide a communication apparatus that reduces power consumption due to display.

Although the application has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A communication apparatus comprising:
a display;
an application processor that is configured to control update of the display; and
a modem processor that is configured to control a modem,
wherein the modem processor is further configured to control the update of the display in place of the application processor.

2. The communication apparatus according to claim 1, wherein the modem processor is further configured to control the update of the display in place of the application processor when a predetermined condition is satisfied.

3. The communication apparatus according to claim 1, wherein the modem processor synchronizes a timing of the update of the display with a timing of reception of the modem.

4. A method for controlling a communication apparatus including a display, an application processor that is configured to control update of the display, and a modem processor that is configured to control a modem, wherein the modem processor controls the update of the display in place of the application processor.
